(19) United States
(12) Patent Application Publication
(10) Pub. No.: US 2023/0321652 A1
(43) Pub. Date: Oct. 12, 2023

(54) Ribonucleic Acid (RNA) Detection Device

(71) Applicant: KEYCORE TECHNOLOGY CORP., Zhubei City (TW)

(72) Inventors: Hsiang-Yu Fan, Zhubei City (TW); Tian-Hsiang MA, Zhubei City (TW); Chen-Hsin LIAO, Zhubei City (TW); Yu-Chi HSU, Zhubei City (TW); Chieh-Jen TENG, Zhubei City (TW)

(21) Appl. No.: 18/296,680

(22) Filed: Apr. 6, 2023

(30) Foreign Application Priority Data
Apr. 6, 2022 (TW) 111113017

(51) Int. Cl. B01L 3/00

(52) U.S. Cl. CPC B01L 3/502715; B01L 2300/023; B01L 2300/027; B01L 2300/12; B01L 2300/0636

(57) ABSTRACT

An ribonucleic acid (RNA) detection device is disclosed, comprising a case, a substrate, at least one display component, and a processing circuit board, wherein one plane on the substrate includes an RNA detection panel and a metal mask cover covering the RNA detection panel, and, when a specimen liquid is dropped onto the RNA detection panel through the detection hole of the case and the concave opening of the metal mask cover, the signal generated by the contact of the specimen liquid with the RNA detection panel is received via the sensor circuit board thus generating the specimen signal determination value which then transferred to the processing circuit board so that the processing circuit board determines whether the specimen liquid includes the virus based on the specimen signal determination value.

### BACKGROUND OF THE INVENTION

### 1. Field of the Invention

The present invention generally relates to a ribonucleic acid (RNA) detection device; in particular, it relates to a detection device for performing RNA sensing processes.

### 2. Description of Related Art

It is well-known that the existing ribonucleic acid (RNA) detection system uses fluorescence brightness changes for detection, and needs to be marked on the measurement platform of the medical institutions, which applies a kind of module structure of glass materials. However, the above-mentioned detection process typically may take two hours or longer, and it is limited to be performed by the measurement platform of the medical institution, and the overall detection cost is high.

Therefore, it is necessary to propose an improved detection method, so that the detection can be performed anywhere more conveniently, and at the same time, the required time for such detection processes can be reduced as well.

Accordingly, on Apr. 20, 2020, the applicant of the present invention applied for the patent titled “RNA detection panel and RNA detection device” of the Republic of China Patent No. I749529; however, the original design mainly utilized the electrode layer and the insulating layer as the main structure, and its design structure was relatively primitive, so that, in practice, it was found that the undesirable phenomenon of noise interference might be quite obvious, as shown in FIGS. 1A and 1B, and it is impossible to accurately identify whether it is has a virus. More seriously, even liquids such as water cannot be accurately identified, which is an extremely terrible issue. Consequently, for the practical application of this product, it is urgent to provide a good solution for improvement.

As a result, the present invention adopts the technology of active thin film transistors, and uses the voltage difference caused by the capacitance variation sensed when the nucleic acid is combined with the probe in order to detect the changed capacitance difference of each pixel, wherein the collocation of the metal mask cover and the sensor chip can be applied to block electrostatic discharge (ESD) and reduce unwanted noise interferences. Therefore, in this way, it is possible to more clearly identify whether the specimen liquid contains the virus, thereby that the present invention can be an optimal solution.

### SUMMARY OF THE INVENTION

The present invention discloses a ribonucleic acid (RNA) detection device, comprising: a case, having a detection hole on the surface thereof for receiving a specimen liquid; a substrate, located inside the case and including: a first layer board, which has an RNA detection panel and a metal mask cover covering the RNA detection panel, in which the RNA detection panel is an active thin film transistor panel, and the metal mask cover has a concave opening whose location corresponds to the position of the detection hole and the surface of the RNA detection panel such that the specimen liquid entered by way of the detection hole can contact the surface of the RNA detection panel through the concave opening, and, in addition, around the RNA detection panel, a metal conductive trigger strip is set up on the first layer board of the substrate, and the metal mask cover presses on the metal conductive trigger strip; a second layer board, electrically connected to the first layer board and being a sensor circuit board having a sensor chip, in which the RNA detection panel is electrically connected to the first layer board by means of multiple conductive components and the sensor circuit board is used to transfer an activation signal to the metal conductive trigger strip and, after amplifying the activation signal through the metal mask cover, enables the specimen liquid on the surface of the RNA detection panel to generate a change of electrical charge, such that the RNA detection panel transfers a detection signal to the detection circuit board in accordance with such a change of electrical charge, and the sensor chip generates a specimen signal determination value based on the detection signal; and a processing circuit board, electrically connected to the detection circuit board and used to receive the specimen signal determination value generated by the sensor chip, in which the processing circuit board includes a control and determination unit which is used to generate a determination result based on the specimen signal determination value.

More specifically, the aforementioned specimen liquid is a salt-free liquid.

More specifically, the dielectric constant of the aforementioned protective layer is 2˜8, and the thickness of the protective layer is less than 50 μm.

More specifically, the aforementioned processing circuit board further includes a display component electrically connected to the control and determination unit for showing the determination result generated by the control and determination unit.

More specifically, the aforementioned display component is an LED light or a display panel.

More specifically, the aforementioned processing circuit board further includes a press-to-start unit electrically connected to the control and determination unit and used to transfer a pressing signal to the control and determination unit such that the control and determination unit can transfer a signal to the sensor circuit board which then sends the activation signal to the metal conductive trigger strip.

More specifically, the aforementioned processing circuit board further includes a wireless transceiver unit connected to the control and determination unit for sending out the determination results generated by the control and determination unit by means of wireless transmissions.

More specifically, the aforementioned wireless transmission includes Bluetooth, Wi-Fi and/or infrared transmissions.

More specifically, the aforementioned processing circuit board further includes a power supply unit connected to the control and determination unit thereby providing the required electrical power for the operations of the processing circuit board.

More specifically, the metal material of the aforementioned conductive component is aluminum, gold, copper or silver.

### BRIEF DESCRIPTION OF THE DRAWINGS

FIG. 1A shows a graph for the measurement results of the conventional ribonucleic acid (RNA) detection device without the specimen liquid.

FIG. 1B shows a graph for the measurement results of the conventional ribonucleic acid (RNA) detection device with the specimen liquid.

FIG. 2A shows a disassembled structure view of the RNA detection device according to the present invention.

FIG. 2B shows an assembled structure view of the RNA detection device according to the present invention.

FIG. 3A shows a simple structure view for the substrate of the RNA detection device according to the present invention.

FIG. 3B shows a basic circuit structure view for the substrate of the RNA detection device according to the present invention.

FIG. 3C shows a circuit principle view for the RNA detection panel of the RNA detection device according to the present invention.

FIG. 4 shows a structure view for the processing circuit board in the RNA detection device according to the present invention.

FIG. 5A shows a view for dropping the salt-free primer into the RNA detection device according to the present invention.

FIG. 5B shows a view for placing the magnetic beads having the specimen into the RNA detection device according to the present invention.

FIG. 5C shows a view for placing the magnetic beads having the specimen into the RNA detection device according to the present invention.

FIG. 6A shows a graph for the measurement results of the RNA detection device without specimen liquid according to the present invention.

FIG. 6B shows a graph for the measurement results of the RNA detection device with specimen liquid according to the present invention.

### DETAILED DESCRIPTION OF THE PREFERRED EMBODIMENTS

Other technical contents, aspects and effects in relation to the present invention can be clearly appreciated through the detailed descriptions concerning the preferred embodiments of the present invention in conjunction with the appended drawings.

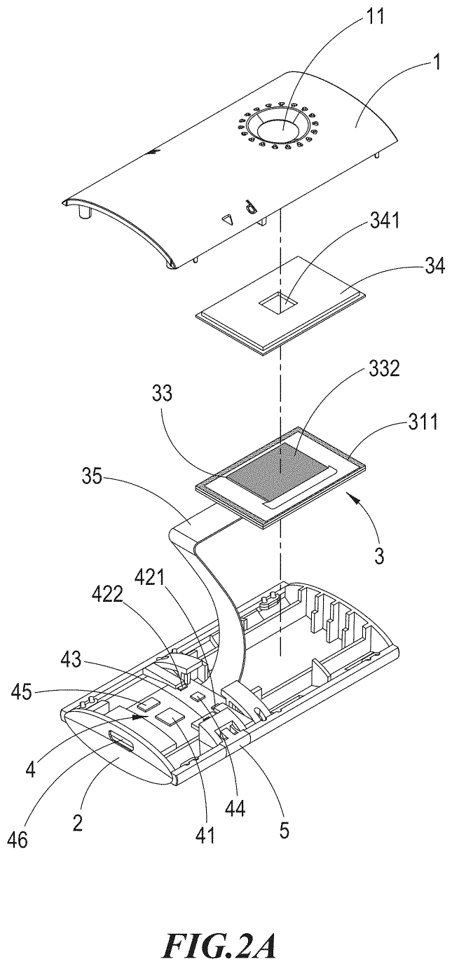

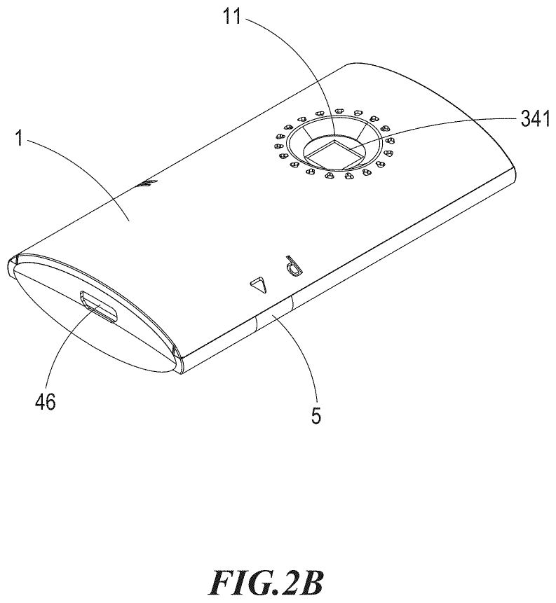

Refer first to FIGS. 2A˜2B, wherein a disassembled structure view and an assembled structure view of the RNA detection device according to the present invention are respectively shown; it can be observed that the illustrated RNA detection device comprises an upper case 1, a lower case 2, a substrate 3 and a processing circuit board 4, in which the surface of the upper case 1 has a detection hole 11 for receiving a specimen liquid, and after the combination of the upper case 1 and the lower case 2, the inside thereof can form an accommodation space, and in which the substrate 3 and the processing circuit board 4 are installed between the upper case 1 and the lower case 2.

The substrate 3 includes a first layer board 31 and a second layer board 32, and the first layer board 31 has an RNA detection panel 33 thereon, in which the RNA detection panel 33 is an active thin film transistor (TFT) panel, and around the RNA detection panel 33, there is a metal conductive trigger strip 311 on the first layer board 31, and in which the active thin film transistor panel is used as a switching component for chip sensing operations, which consists of multiple metal oxide semiconductor (MOS) switching components, such that the switching component can be switched by means of the clock to allow a plurality of salt-free primers to be combined with the specimen liquid, and the small electrical signal difference circulating on the thin film transistors can be stored in the plurality of switching components in order to be sent back to the receiving multiplexer and then transferred to the sensor chip; in addition, the RNA detection panel 33 has a certain range for the position of the sensor unit, and the position is used as a specimen sensor area.

Also, the surface of the RNA detection panel 33 is covered with a metal mask cover 34 which presses on the metal conductive trigger strip 311. The metal mask cover 34 has a concave opening 341 whose location corresponds to the position of the detection hole 11 and the surface of the RNA detection panel 33.

Moreover, the second layer board 32 is a sensor circuit board has a sensor chip 321 and a plurality of electronic components 322 thereon, in which the sensor chip 321 and the sensor circuit board of the second layer board 32 can be connected in practice by means of driver chips that are packaged in LGA/BGA/QFN, chip on film (COF), chip on board (COB) or chip on glass (COG) technologies. The sensor chip 321 may be replaced with another sensor chip based on different applications and requirements.

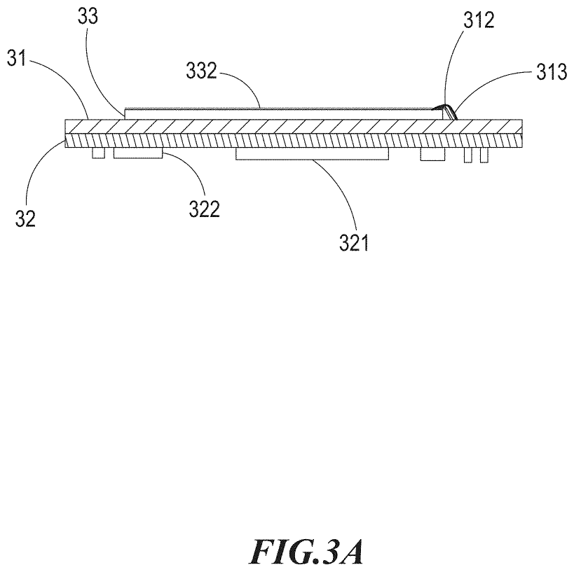

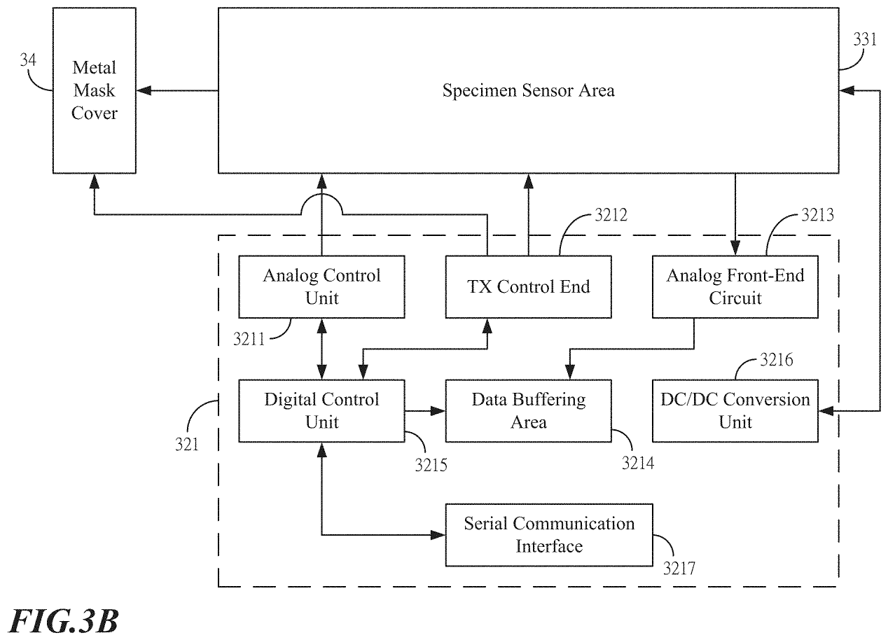

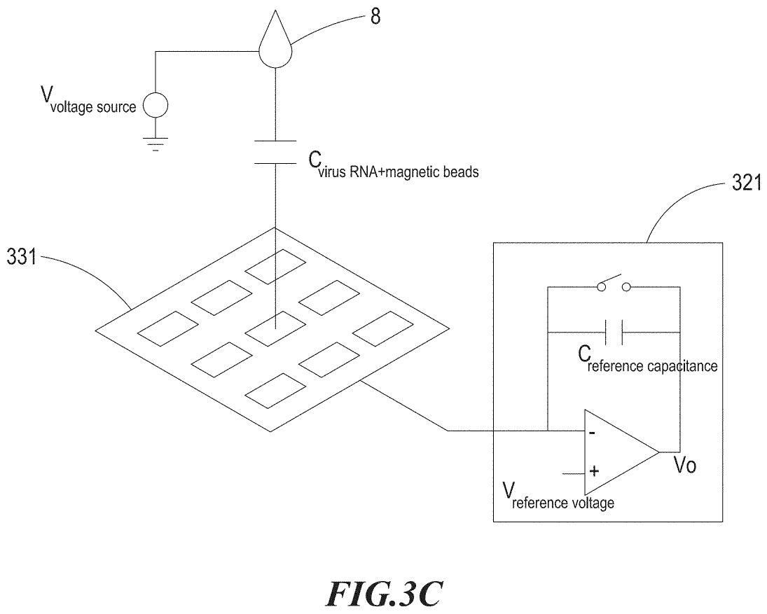

As shown in FIG. 3A, it can be seen that the RNA detection panel 33 is first electrically connected to the first layer board 31 through a plurality of conductive components 312, and the metal material of the conductive components 312 may be aluminum, gold, copper or silver, which can be connected to the first layer board 31 by means of hot pressing or wire-bond processes and ACF conductive adhesive. In the present embodiment, it is connected by the wire-bond process, and the wire-bond will finally be glued to form a glue layer 313. Additionally, in order to enhance the effect of preventing ESD (Electrostatic discharge ESD), a protective layer 332 can be combined on the surface of the RNA detection panel 33 (the protective layer is made of hard- coating, ultra-thin glass, polyimide film (pi film), scratch-resistant hard coating layer), and the dielectric constant of the protective layer may be 2˜8 (2, 3, 4, 5, 6, 7 or 8), and the thickness of the protective layer may be less than 50 μm (e.g., 1, 2.5, 5, 7.5, 10, 12.5, 15, 17.5 , 20, 22.5, 25, 27.5, 30, 32.5, 35, 37.5, 40, 42.5, 45, 47.5 or 49).

Besides, the first layer board 31 and the second layer board 32 are electrically connected through the through-hole technology of the circuit board (a through-hole is a process for connecting surfaces to each other through the insulating part of the circuit board, and common methods thereof may include wire bonding, plated through holes, rivet through holes, or the like).

In the present embodiment, the first layer board 31 and the second layer board 32 can be implemented by using a two-layer circuit substrate or a single-layer and double-sided circuit substrate.

FIG. 3B shows a basic circuit structure view for the substrate 3, in which the sensor chip 321 of the sensor circuit board on the second layer board 32 can transmit an activation signal (voltage) to the metal conductive trigger strip 311 and send the signal (voltage) to the under-test specimen through the metal mask cover 34, and then a change of electrical charge can be generated in the specimen liquid located on the surface of the RNA detection panel 33, such that the RNA detection panel 33 transfers a detection signal to the sensor circuit board of the second layer board 32 based on the change of electrical charge, and the sensor chip 321 generates a specimen signal determination value based on the generated detection signal.

It should be noticed that the sensor chip 321 includes:
(1) an analog control unit 3211 (Analog Control), used to control the TX sensor circuit of the specimen sensor area on the surface of the RNA detection panel 33;
(2) a TX control end 3212 (TX Control), used to trigger the specimen sensor area to send signals, and the metal conductive trigger strip 311 is conducted to the metal mask cover 34;
(3) an analog front-end circuit 3213 (Analog Front End), receiving the sensing value sensed by the specimen sensor area (specimen sensor);
(4) a data buffer 3214 (Frame Buffer), sequentially sending the sensing values sensed by the analog front-end circuit 3213 to the data buffer 3215 for temporary storage;
(5) a digital control unit 3215 (Digital Control), converting the sensing value received by the analog front-end circuit 3213 into digital codes in the data buffer 3215;
(6) a DC/DC conversion unit 3216 (DC/DC), used as an internal circuit power supply sensor;
(7) a serial communication interface 3217 (SPI Interface), used for external communications, which can transfer the sensing value sensed and converted into digital codes to the outside of the sensor chip 321 (e.g., MCU), and can also enable external sensor controls on the sensor chip 321.

The RNA detection panel 33 can be fabricated by using a yellow light etching process, and the circuit principle of the RNA detection panel 33 is shown in FIG. 3C, in which, when the liquid 8 containing the specimen contacts the specimen sensor area 331 for detection, the specimen liquid can form a capacitance (C_{virus RNA+magnetic beads}) through the metal conductive trigger strip 311 and the conduction of the metal mask cover 34, and the sensor chip 321 can form a reference capacitance (C_{reference capacitance}) between each column of circuit components (switches) on the RNA detection panel 33 and the sensor unit of the sensor chip 321.

The sensor chip 321 detects the capacitance (C_{virus RNA+magnetic beads}) generated in response to the contact with the specimen liquid on the specimen sensor area 331 of the RNA detection panel 33 as well as the reference capacitance (C_{reference capacitance}) formed by each row of the circuit components (switches) and the sensor unit on the sensor chip 321.

It can be understood that the principle of the present invention is to output the voltage to the specimen (magnetic beads carrying viral RNA) through the V_{voltage source} (in the present invention, the metal conductive trigger strip 311 cooperates with the metal mask cover 34 in order to achieve the effect of outputting the voltage to the specimen), and then the capacitance in the magnetic bead specimen (C_{virus RNA+magnetic beads}) can be conducted to the specimen sensor area 331 so that the specimen sensor area 331 can be matched with the capacitance of the underlying capacitor plate (C_{reference capacitance}).

The output voltage (Vo) will be proportional to the capacitance of the specimen (C_{virus RNA+magnelic beads}), so that if the capacitance value of the object-to-be-tested becomes larger, the Vo value will be also synchronously amplified; and, finally, the output voltage (Vo) will be conducted into a digital-to-analog (ADC) component and parsed into a digital signal, and then communicated to the control and determination unit (e.g., MCU) of the processing circuit board 4 through a serial communication interface (SPI) for storage, thereby that the control and determination unit can compare and compute the stored difference signals and display the results by means of the display component (e.g., LED lights).

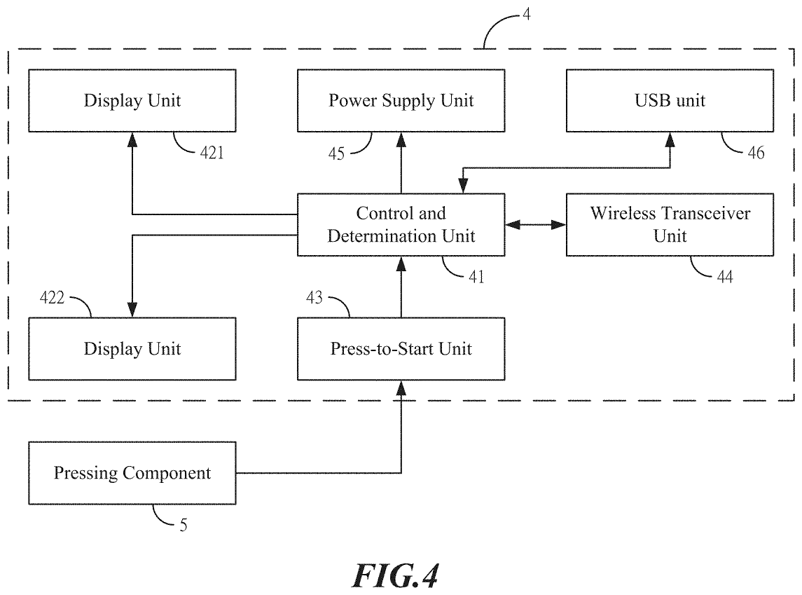

The processing circuit board 4 is electrically connected to the sensor circuit board (for example, connected via the cable 35), and the processing circuit board 4 is used for receiving the specimen signal determination value generated by the sensor chip 321; in addition, as shown in FIG. 4, the processing circuit board 4 includes at least a control and determination unit 41 which is used for determining the contents of the specimen signal determination value so as to generate a determination result. In the present embodiment, the control and determination unit 41 is a chip or a microprocessor (MCU).

The processing circuit board 4 further includes display elements 421, 422 which are used to display the determination result generated by the control and determination unit 41, in which the display elements 421, 422 are LED lamps, but may be also designed as using a display panel.

Moreover, the processing circuit board 4 further includes a press-to-start unit 43 for externally pressing a pressing component 5 in order to transmit a pressing signal to the control and determination unit 41 by way of the press-to-start unit 43, and the control and determination unit 41 can transfer a signal to the sensor circuit board of the second layer board 32, and then the sensor circuit board transfers the activation signal to the metal conductive trigger strip 311.

The processing circuit board 4 further includes a wireless transceiver unit 44 for transmitting the determination result generated by the control and determination unit 41 by means of wireless transmissions, in which the wireless transmissions may be Bluetooth, Wi-Fi or/and infrared transmission.

The processing circuit board 4 further includes a USB unit 46. The USB unit 46 is connected to an external device (pc/mobile device) through a transmission line for controlling and transmitting the detection results. The USB unit 46 is electrically connected to the control and determination unit 41 to send out the determination result generated by the control and determination unit 41.

Besides, the processing circuit board 4 further includes a power supply unit 45 for providing the power required for the operations of the processing circuit board 4.

Also, it should be appreciated that, in the present embodiment, before dripping the specimen liquid into the detection hole 11, the collection rod needs to be stirred in a first accommodating test tube internally including magnetic beads, then the collection rod can be discarded, and the first accommodating test tube is covered with a lid and turned over; afterward, a magnetic bead collection rod can be placed into the first accommodating test tube in order to allow the magnetic beads to magnetically attach onto the magnetic bead collection rod. The surface of the aforementioned magnetic beads has an adsorption layer which includes a silicon material and a primer, and said silicon material can be, e.g., silicon dioxide, and can be combined with the primer, and the nucleic acid fragment specifically combined with the nucleic acid to be detected through the primer so as to carry the nucleic acid to be detected; hence, in this way, the adsorption layer can effectively adsorb the nucleic acid contained in the biological specimen.

Subsequently, the magnetic bead collection rod that adsorbs the magnetic beads can be placed into the second accommodating test tube, and pull out the magnetic rod in the magnetic bead collection rod, such that the magnetic beads can fall into the solution contained in the second accommodating test tube; following this, stirring for washing away the salt, and finally inserting the magnetic rod back into the magnetic bead collection rod and stirring up and down in the second accommodation test tube to adsorb the magnetic beads.

Next, put the magnetic bead collection rod that adsorbs the magnetic beads into a third accommodation test tube, and once again, pull out the magnetic rod in the magnetic bead collection rod such that the magnetic beads can fall into the solution contained in the third accommodation test tube; then, stirring again to wash away the salt again, and finally inserting the magnetic rod back into the magnetic bead collection rod, and stirring up and down in the third accommodation test tube in order to adsorb the magnetic beads.

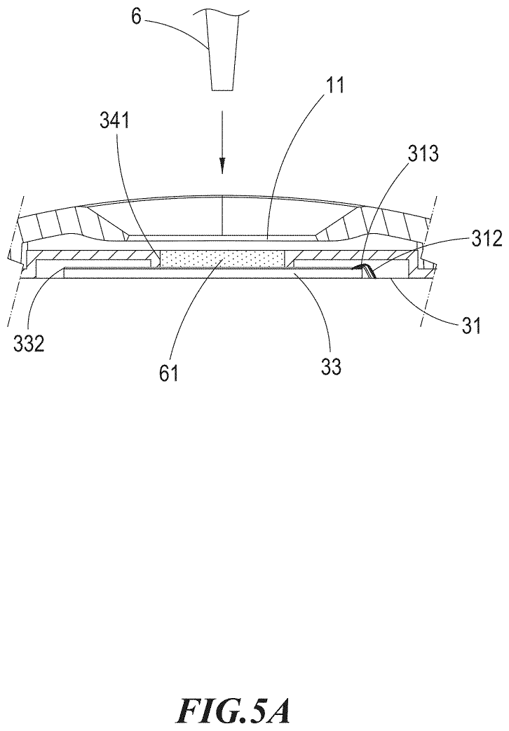

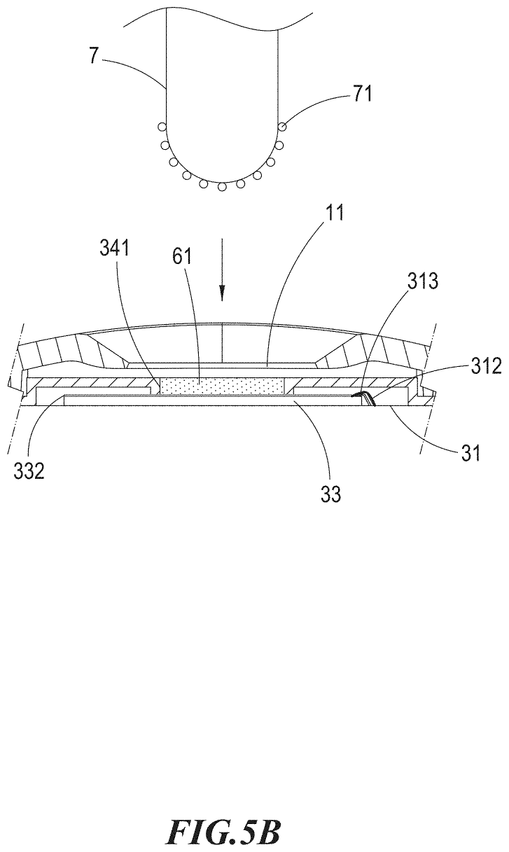

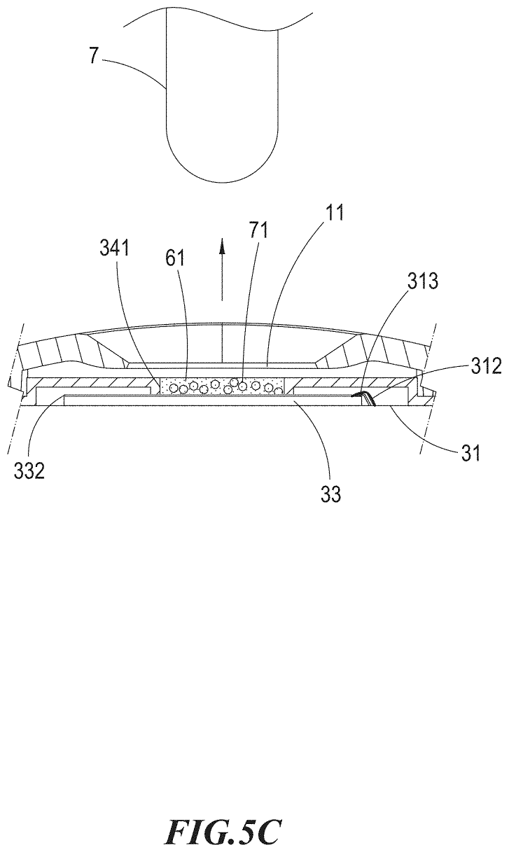

After that, as shown in FIG. 5A, a dropper 6 is used to absorb a salt-free liquid 61 (the main component of the salt-free liquid is pure water); it can be seen from the Figure that, the salt-free liquid 61 can be dropped into the detection space formed by the detection hole 11, the concave opening 341 and the RNA detection panel 33 (it should be noticed that such salt-free liquid is used to verify whether the detection function can be normally operable); afterward, the pressing component 5 can be pressed down to detect whether it is abnormal (for example, in the present embodiment, the display component 421 is a green LED lamp, and the display component 422 is a red LED lamp, such that, if it is determined there exists abnormality, then the display component 422 can be driven to emit red light; it should be understood that the present embodiment may also alternatively apply a single multi-color display component to achieve the same effect).

Next, as shown in FIGS. 5B and 5C, the tip of the magnetic bead collection rod 7 contacts the salt-free liquid 61 to allow the magnetic beads 71 to enter the salt-free liquid 61, and then press down the pressing component 5; in addition, the display components 421 and 422 may flash alternately to indicate that the detection procedure is currently in progress, and the different detection results are exemplarily illustrated as follows:
(1) Driving the display component 422 to emit light, indicating that it may be infected by COVID-19;
(2) Driving the display component 421 to emit light, indicating that it may not be infected by COVID-19.

FIGS. 5A to 5C of the present invention mainly show the structure of the detection space formed by the detection hole 11, the concave opening 341 and the RNA detection panel 33, and for brevity of the views, the rest of the structures are not shown and the structure under the RNA detection panel 33 should refer to the structure illustrated in FIG. 3A.

Next, to further explain the mechanism for determining whether there is a COVID-19 virus contained therein, in the present embodiment, the specimen liquid containing RNA of COVID-19 virus is used for measurement, and the sensor chip operates such that, according to the changed capacitance difference (i.e., the specimen signal determination value) at each pixel (0˜255) being between 120˜130, when the user's saliva (i.e., the specimen) is under detection, suppose the detected specimen signal determination value is located between 120 and 130, it indicates that the user may be infected by COVID-19; otherwise, it means that the user may not be infected by COVID-19.

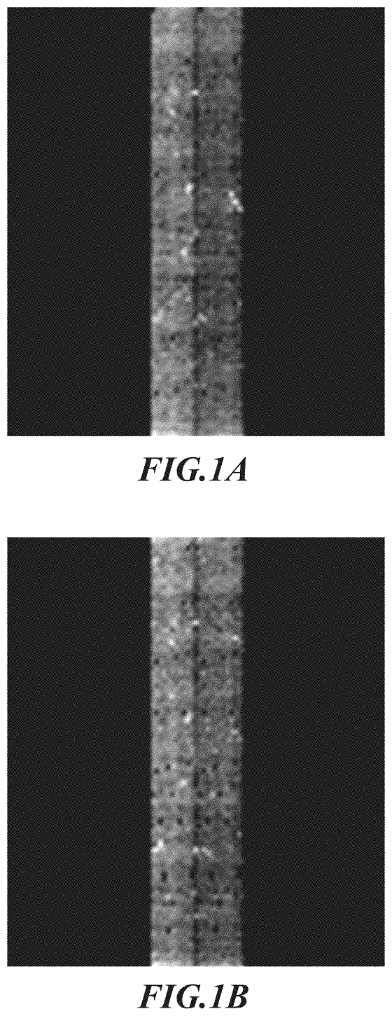

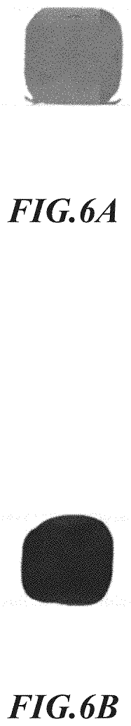

Therefore, as shown in FIG. 6A, from the measurement results of the sensor chip 321 under the condition of no specimen liquid, it can be clearly seen no obvious interference occurs; further from FIG. 6B, after adding the specimen liquid, the measurement results of the sensor chip 321 is also very clear, and obviously there is no interference phenomenon, thus demonstrating the true value of such measurements. So, in comparison with the measurement results (FIGS. 1A and 1B) obtained by the technology described in the patent “RNA detection panel and RNA detection device” of the R.O.C. Patent No. 1749529, the present invention is obviously more advanced and practical.

In addition to detecting RNA solution, the device of the present invention can detect DNA, proteins, peptides, enzymes, amino acids, antibodies, hormones, organic and/or inorganic pollutants, pesticides, chemicals or perfluorinated surfactants in water, or a combination thereof.

Compared with other conventional technologies, the RNA detection device according to the present invention provides the following advantages:
(1) The present invention uses the technology of active thin film transistors, and applies the voltage difference caused by the capacitance change sensed when the nucleic acid is combined with the probe in order to detect the changed capacitance difference of each pixel; herein, the conjunctive usage of the metal mask cover and the sensor chip can block the electrostatic discharge (ESD) and reduce the interference of noise, so that the present invention is able to more clearly identify whether the specimen liquid contains viruses.
(2) Seeing that the currently available RNA detection systems usually apply fluorescence detection approaches and include a control unit and an RNA detection device, it may require longer process time, herein the RNA detection device includes a coating layer, plural sensor layers connected to the control unit, and at least one primer layer enabling interactions of the specimen liquid in contact with the panel. Compared with the prior art utilizing silicon wafers as sensor substrates for detection, the present invention can achieve the effect of complexity reduction by means of the characteristics of thin film transistors.
(3) The present invention allows to install the RNA detection panel of the sensor substrate in accordance with different application requirements so as to effectively detect the specimen liquid containing DNA, RNA, microRNA, IgM and IgG.
(4) It should be appreciated that the structure of the RNA detection module in the present invention detects by means of the changes regarding to the capacitance and dielectric constant and does not require any specific measurement platform for operations, thereby allowing users to operate the device at home, and the detection can be performed anywhere more conveniently, thus effectively reducing the duration of time for detection processes, which can be significantly shortened from currently two days to less than 5 minutes.

It should be understood that the present invention has been disclosed through the detailed descriptions of the aforementioned embodiments. However, the descriptions previously set forth are by no means to limit the present invention; rather, those skilled ones in relevant arts can make appropriate alternations or modifications thereto in practice after understanding the technical characteristics and embodiments of the present invention without departing from the scope and spirit thereof As a result, the scope of the present invention applied for legal protections should be only delineated by the claims attached in the present specification.

What is claimed is:

1. A ribonucleic acid (RNA) detection device, comprising:
a case, having a detection hole on the surface thereof for receiving a specimen liquid;
a substrate, located inside the case and including:
a first layer board, which has an RNA detection panel and a metal mask cover covering the RNA detection panel, in which the RNA detection panel is an active thin film transistor panel, and the metal mask cover has a concave opening whose location corresponds to the position of the detection hole and the surface of the RNA detection panel such that the specimen liquid entered by way of the detection hole can contact the surface of the RNA detection panel through the concave opening, and, in addition, around the RNA detection panel, a metal conductive trigger strip is set up on the first layer board of the substrate, and the metal mask cover presses on the metal conductive trigger strip, and the surface of the RNA detection panel is combined with a protective layer;
a second layer board, electrically connected to the first layer board and being a sensor circuit board having a sensor chip, in which the RNA detection panel is electrically connected to the first layer board by means of multiple conductive components and the sensor circuit board is used to transfer an activation signal to the metal conductive trigger strip and, after amplifying the activation signal through the metal mask cover, enables the specimen liquid on the surface of the RNA detection panel to generate a change of electrical charge, such that the RNA detection panel transfers a detection signal to the detection circuit board in accordance with the change of electrical charge, and the sensor chip generates a specimen signal determination value based on the detection signal; and
a processing circuit board, electrically connected to the detection circuit board and used to receive the specimen signal determination value generated by the sensor chip, in which the processing circuit board includes a control and determination unit which is used to generate a determination result based on the specimen signal determination value.

2. The RNA detection device according to claim 1, wherein the specimen liquid is a salt-free liquid.

3. The RNA detection device according to claim 1, wherein the dielectric constant of the protective layer is 2 to 8, and the thickness of the protective layer is less than 50 μm.

4. The RNA detection device according to claim 1, wherein the processing circuit board further includes a display component electrically connected to the control and determination unit for showing the determination result generated by the control and determination unit.

5. The RNA detection device according to claim 4, wherein the display component is an LED light or a display panel.

6. The RNA detection device according to claim 1, wherein the processing circuit board further includes a press-to-start unit electrically connected to the control and determination unit and used to transfer a pressing signal to the control and determination unit such that the control and determination unit can transfer a signal to the sensor circuit board which then sends the activation signal to the metal conductive trigger strip.

7. The RNA detection device according to claim 1, wherein the processing circuit board further includes a wireless transceiver unit connected to the control and determination unit for sending out the determination results generated by the control and determination unit by means of wireless transmissions.

8. The RNA detection device according to claim 7, wherein the wireless transmission includes Bluetooth, Wi-Fi and/or infrared transmissions.

9. The RNA detection device according to claim 1, wherein the processing circuit board further includes a power supply unit connected to the control and determination unit thereby providing the required electrical power for the operations of the processing circuit board.

10. The RNA detection device according to claim 1, wherein a metal material of the conductive component is aluminum, gold, copper or silver.

11. The RNA detection device according to claim 1, wherein the processing circuit board further comprises a USB unit electrically connected to the control and determination unit, and the USB unit is connected to an external device through a transmission line to send out the determination result generated by the control and determination unit.
